(19) United States
(12) Patent Application Publication
(10) Pub. No.: US 2012/0133230 A1
(43) Pub. Date: May 31, 2012

(54) SPLIT-POLE MAGNETIC MODULE FOR ELECTRIC MACHINE ROTORS

(76) Inventor: Patrick Lee JANSEN, Scotia, NY (US)

(21) Appl. No.: 12/956,538

(22) Filed: Nov. 30, 2010

(51) Int. Cl. H02K 1/28; H02K 15/16; H02K 15/00

(52) U.S. Cl. 310/156.12; 29/596; 29/593

(57) ABSTRACT

A split-pole magnetic module for use in large permanent magnet machines. The split-pole magnetic module has at least two permanent magnets positioned within a lamination stack at an angle relative to each other so that magnetic flux enters a first portion of an outer surface of the lamination stack and exits a second portion of the outer surface of the lamination stack. Consequently, little if any magnetic flux passes through, or is carried by, the support structure of a rotor or a stator.

### CROSS-REFERENCE TO RELATED APPLICATIONS

### Statement Regarding Federally Sponsored Research or Development

Not Applicable

### NAMES OF PARTIES TO A JOINT RESEARCH AGREEMENT

Not Applicable

### REFERENCE TO A SEQUENCE LISTING, A TABLE, OR COMPUTER PROGRAM LISTING APPENDIX SUBMITTED ON COMPACT DISC

Not Applicable

### BACKGROUND OF THE INVENTION

1. Field of the Invention

The field of the invention relates to power systems generally, and more particularly to certain new and useful advances in permanent magnets motors and generators that can be applied to various applications, such as but not limited to, multi-megawatt wind turbine generators, of which the following is a specification, reference being had to the drawings accompanying and forming a part of the same.

2. Description of Related Art

The assembly of large permanent magnet machines is complicated by the presence of significant magnetic fields and forces. This problem caused some manufacturers to develop expensive tooling, fixturing and processes to safely assemble and handle magnetized rotor poles, rotor assemblies, and entire permanent magnet machines. It caused other manufacturers to develop large, expensive magnetizers to magnetize permanent magnet rotors after assembly, but before insertion into the permanent magnet machine. However, known copper-based magnetizers typically cannot magnetize large interior permanent magnet rotors having NdFeB magnets in a cost effective manner.

One example of a system that uses a large (multi-megawatt) permanent magnet machine is the power generating wind turbine 10 shown in FIG. 1. The wind turbine's tower 12 extends from a base 14. The tower's free end supports a nacelle bedplate 18 to which a nacelle 16 is attached. A drive unit (not shown) allows the nacelle 16 to rotate about a horizontal plane. A main shaft 20 protrudes from the nacelle 16. A free end of the main shaft 20 is coupled with the rotor head 24, to which a plurality of blades 26 is radially attached. The opposite end of the main shaft 20 is coupled to a transmission by an input carrier (not shown), which shares a common central axis 22 with the main shaft. A cut-away view of the nacelle 16 is shown in FIG. 2. A power generation system 110 is housed within the nacelle 16 and includes a transmission 112. The transmission 112 couples with, and is positioned between, a generator 114, which is a type of permanent magnet machine, and the main shaft 20 (of FIG. 1). One or more torque couplings 104 couple the nacelle bed-plate 18 with the power generation system 110. Transformers (not shown) may be housed in the space in the nacelle 16 behind the power generation system 110.

In one known example the generator 114 is a wound-field synchronous generator. FIG. 3 illustrates a rotor 30 for such a generator. The known rotor 30 includes a plurality of rotor poles 34 that are attached to the periphery of a circular rotor yoke 32. FIG. 4 illustrates a cross-sectional view of a rotor pole 34. Referring to FIGS. 3 and 4, each rotor pole 34 includes a lamination stack 38 with at least one bolting bar 42 extending the length of the lamination stack 38. The lamination stack 38 typically includes a plurality of steel sheets that are punched or laser cut. The steel sheets are often of electrical grade steel, but can be any ferromagnetic material including common-low carbon steel as well as high permeability magnetic alloys. The steel sheet thicknesses are typically between 0.025″ and 0.125″ thick, but can be smaller or larger.

At least one end plate (not shown) is mounted to the end of each lamination stack 38 using bolts (not shown) screwed into threaded holes in the one or more bolting bars 42, or via equivalent attachment means. The end plates compress the lamination stack 38, thereby creating a rigid structure. The rotor pole 34 is surrounded by a field winding 40 typically consisting of insulated metal, e.g., copper or aluminum, turns. A generator field exciter (not shown) is directly or indirectly electrically connected to the field windings of each rotor pole 34 to supply electrical current through the field windings 40. The electrical current flowing therein produces a magnetic flux to create either a north or south magnetic pole at the rotor pole airgap surface. Thus, successive poles on the rotor alternate between north and south poles.

The rotor pole 34 has a mounting surface and an airgap surface, and the sidewalls 35 of each rotor pole 34 are separated from the sidewalls of adjacent rotor poles by an airgap 37. This airgap 37 provides cooling to each rotor pole 34, but means that fewer rotor poles 34 can be included for a rotor yoke 32 of a given radius.

Typically, each rotor pole 34 is mounted, and rigidly attached, to the rotor yoke 32 by pairs of mounting bolts 36 that pass through the rotor yoke 32 and screw into threaded holes in the bolting bars 42. In other cases, some known rotor yokes 32 have pole alignment features, such as mating keyways or shouldered surfaces/joints, which permit the rotor poles 34 to be attached to the rotor yoke 32 using a single row of mounting bolts 36. Because the magnetic flux in this design passes through the rotor yoke 32, the rotor yoke is a ferromagnetic material, typically low-carbon steel. Accordingly, the rotor yoke 32 tends to be thick and heavy.

FIGS. 5 and 6 depict known alternative rotor poles 50 and 60, respectively, for use in permanent magnet generators. Unlike the rotor pole 34 of FIG. 4, each of the rotor poles 50 (FIG. 5) and 60 (FIG. 6) does not have a field winding 40. Instead, rotor pole 50 includes a permanent magnet 52, positioned substantially orthogonally to, and spaced apart from, the two bolting bars 42. Rotor pole 60 has two separate permanent magnets 54 and 56. The bar magnets 54 and 56 are angled relative to each other, and each is spaced apart from each other and from one of the bolting bars 42, but, as shown in FIGS. 4, 5 and 6, each rotor pole 34, 50 and 60 has magnetic flux 44 running from a magnetic north pole 46 arranged along an interior portion of the support structure 32 to a magnetic south pole 48 arranged along an exterior portion of the rotor pole lamination stack 38. In other words, the magnetic flux 44 enters one (north) side of the rotor pole lamination stack 38 and exits an opposite (south) side of the rotor pole lamination stack 38. Regardless of whether rotor pole 34, 50 or 60 is used, the rotor yoke 32 (FIG. 3) carries at least some of the magnetic flux 44, and this factor tends to increase the size and/or mass of the rotor 30, rather than decrease it.

One disadvantage of the known rotor poles 50 and 60 is evident during assembly and servicing of the individual rotor poles as well as the entire rotor. As illustrated in FIGS. 5 and 6, the permanent magnets are oriented such that magnetic flux attempts to both enter and exit the rotor poles, thereby exposing nearby equipment and personnel to potentially high magnetic field and magnetic forces. These fields and forces dictate that elaborate and complicated (and expensive) equipment/fixturing and processes be developed and implemented for assembly of the individual rotor poles, and for mounting of the poles onto the rotor yoke 32. Similarly complicated and expensive equipment/fixturing and processes are required for servicing of the individual rotor poles in the event of a failure or mechanical problem in the field.

### BRIEF SUMMARY OF THE INVENTION

A split-pole magnetic module for use on a rotor or stator of an electrical machine, such as, a large permanent magnet machine, examples of which include, but not limited to, a motor, a generator, an alternator, a dynamo, and the like. The rotor pole comprises two spaced-apart permanent magnets and a compression bar. Each permanent magnet is oriented with a magnetic polarity opposite the magnetic polarity of the other. For example, a first magnet of the two spaced-apart magnets has a magnetic north polarity facing in an outward direction, and a second magnet of the two-spaced apart magnets has a magnetic south polarity.

Advantageously, embodiments of the new split-pole magnetic module have magnetic flux that is self-contained within the interior region of the lamination stack (i.e, closest to the rotor yoke). The rotor yoke is thereby free to be optimized for providing structural support of the rotor pole modules; i.e, it is not required to carry magnetic flux. Furthermore, and even more importantly, a simple magnetic keeper is provided in one or more embodiments to contain the magnetic flux entering and exiting the outer surface of each split-pole module, thereby self-containing the magnetic flux within each module/keeper assembly, and permitting the assembly and handling of individual rotor pole modules, as well as the complete rotor, without high magnetic fields or magnetic forces. Use of multiple magnetic keepers facilitates insertion of an assembled rotor, with embodiments of the new split-pole magnetic modules coupled thereto, into a stator. Thus, embodiments of the new split-pole magnetic module eliminate many of the manufacturing complexities and/or undesirable features formerly associated with prior rotor poles and rotors.

Moreover, since embodiments of the new split-pole magnetic module can be placed side-by-side about the circumference of a rotor support structure, predetermined portions of adjacent split-pole magnetic modules will combine to form a common magnetic pole. This was not possible in the prior approaches described above. Additionally, each of the two magnets in each split-pole magnetic module is angled relative to the other to prevent the rotor support structure from carrying magnetic flux. Consequently, the size and/or mass of a rotor for a permanent magnet machine can be decreased because the rotor support structure no longer needs to be formed of a ferromagnetic material; e.g., the rotor support structure could be formed of aluminum or a carbon composite to reduce weight.

Additionally, one or more sidewalls of the new split-pole magnetic module may have a portion of a duct formed therein, so that corresponding portions of the duct mate together to form a cooling duct when the new split-pole magnetic modules are positioned adjacent each other. This feature also is not present in the prior approaches described above.

Embodiments of the new split-pole magnetic module and/or embodiments of one or more methods for manufacturing and/or assembling the same, described herein reduce or eliminate many of the challenges previously associated with manufacturing and/or assembling large (“multi-megawatt”) permanent magnet machines. For example, use of the split-pole magnetic module allows many standard manufacturing practices for salient-pole, wound-field, synchronous generators to be retained, which helps reduce manufacturing costs.

Embodiments of the new split-pole magnetic module described herein will be used for large permanent magnet machines, such as generators and/or motors, that have any number of poles, particularly in large permanent magnet machines that have a high pole count, e.g., about twelve poles or higher.

Other features and/or advantages of the various embodiments of the invention will become apparent by reference to the following description taken in connection with the accompanying drawings.

### BRIEF DESCRIPTION OF THE SEVERAL VIEWS OF THE DRAWINGS

Reference is now made briefly to the accompanying drawings, in which:

FIG. 1 shows an illustration of a conventional power generating wind turbine;

FIG. 2 shows a conventional power generation system enclosed by a nacelle;

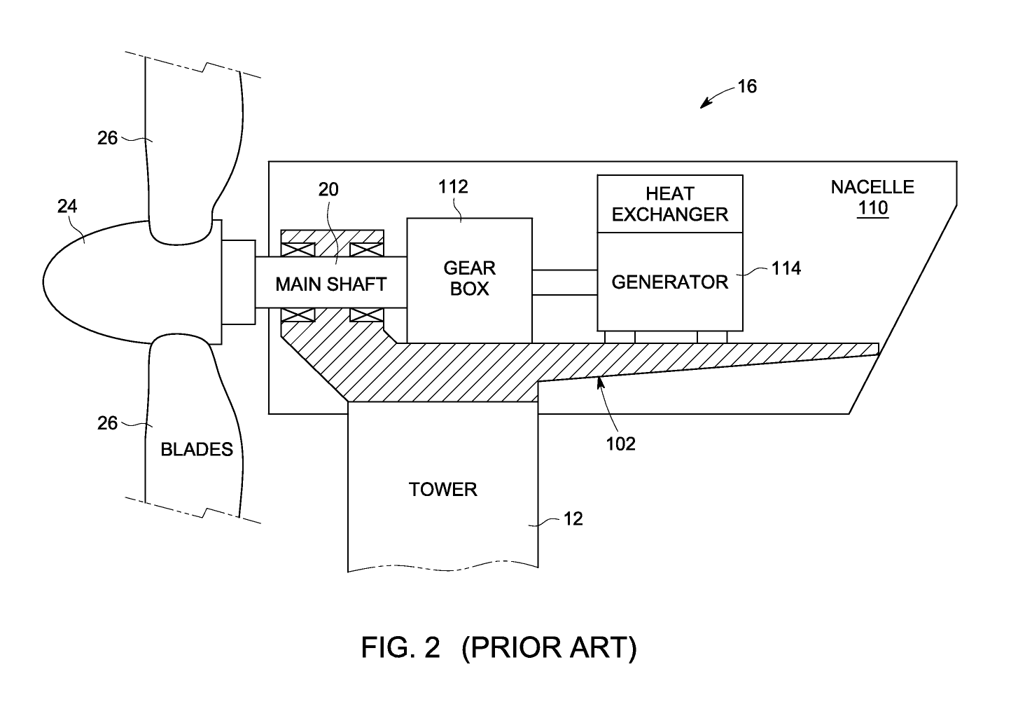

FIG. 3 shows one-half of a conventional rotor;

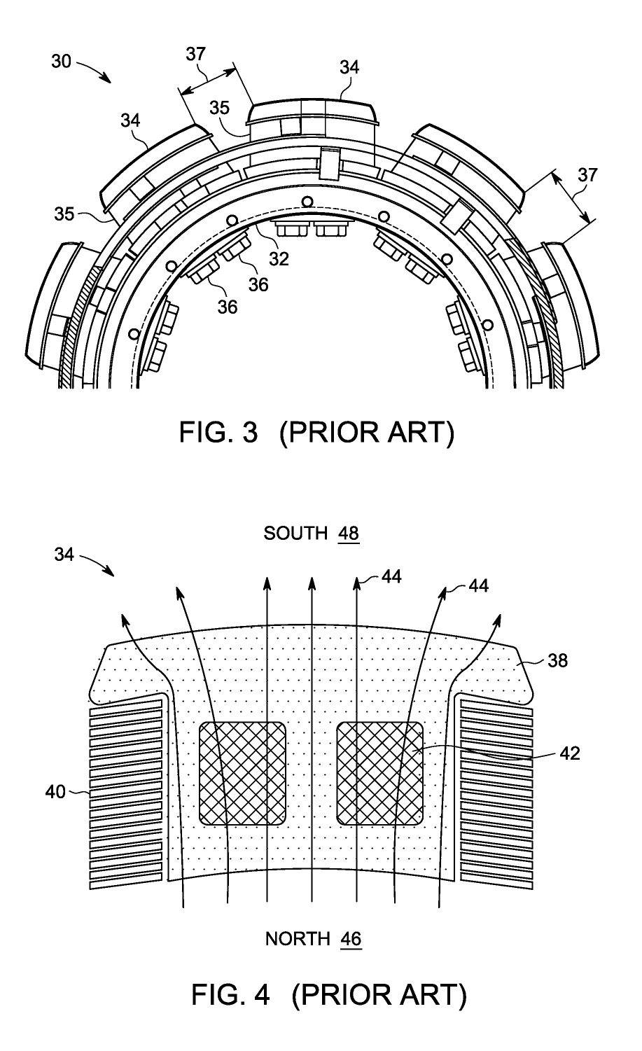

FIGS. 4, 5, and 6 depict examples of conventional rotor poles;

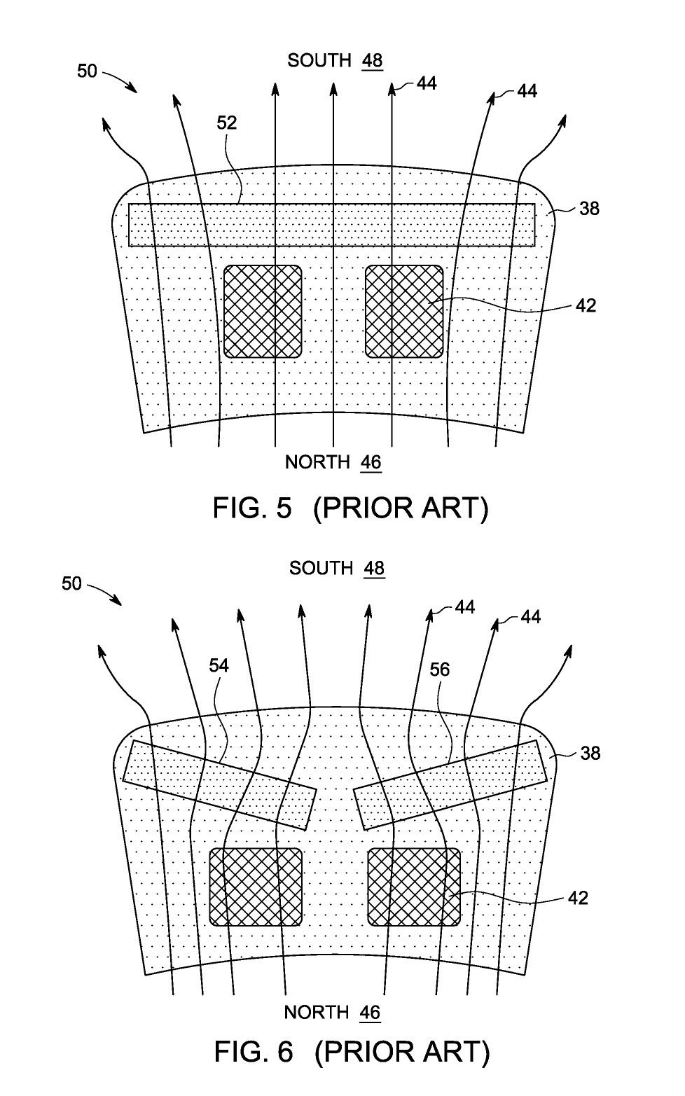

FIG. 7A is a perspective, exploded-parts view of an embodiment of a new split-pole magnetic module;

FIG. 7B is a perspective top view of the embodiment of the split-pole magnetic module of FIG. 7A, shown assembled;

FIG. 7C is a perspective bottom view of the embodiment of the split-pole magnetic module of FIG. 7B, shown assembled;

FIG. 8 depicts one-half of an embodiment of a rotor of a permanent magnet machine, such as a generator and/or a motor, having multiple split-pole magnetic modules, such as shown in FIGS. 7A, 7B and 7C, coupled with the rotor support structure;

FIG. 9 depicts an embodiment of a magnetic keeper and a non-magnetic spacer that are coupled with the split-pole magnetic module of FIGS. 7A, 7B and 7C;

FIG. 10 depicts an alternative embodiment of a rotor and a split-pole magnetic module;

FIG. 11 illustrates insertion of an embodiment of a completed rotor, with split-pole magnetic modules and magnetic keepers attached, into a stator during assembly of a large permanent magnet machine;

FIG. 12 illustrates an optional mechanism for testing and/or correcting balance of a rotor, which comprises multiple split-pole magnetic modules, after the rotor is fully assembled, but before it is inserted within a stator;

FIG. 13 depicts a method for using at least one or more of the magnetic keepers of FIG. 9 to assemble one or more split-pole magnetic modules of FIGS. 7A, 7B, 7C onto a rotor support structure; and

FIG. 14 depicts a method for inserting the rotor of either FIG. 8 or FIG. 10 into a stator while removing one or more magnetic keepers from one or more of the split-pole magnetic modules.

Like reference characters designate identical or corresponding components and units throughout the several views, which are not to scale unless otherwise indicated.

### DETAILED DESCRIPTION OF THE INVENTION

Embodiments of the invention provide a new split-pole permanent magnet rotor and/or methods of manufacturing and/or assembling the same for use in, or as part of, a large (multi-megawatt) permanent magnet machine. Non-limiting examples of a permanent magnet machine are a permanent magnet generator for a wind turbine, a drive train product for a wind turbine, and an electrical machine for use in other applications, such as power generation and/or vehicle propulsion.

### Components, Features and Structure

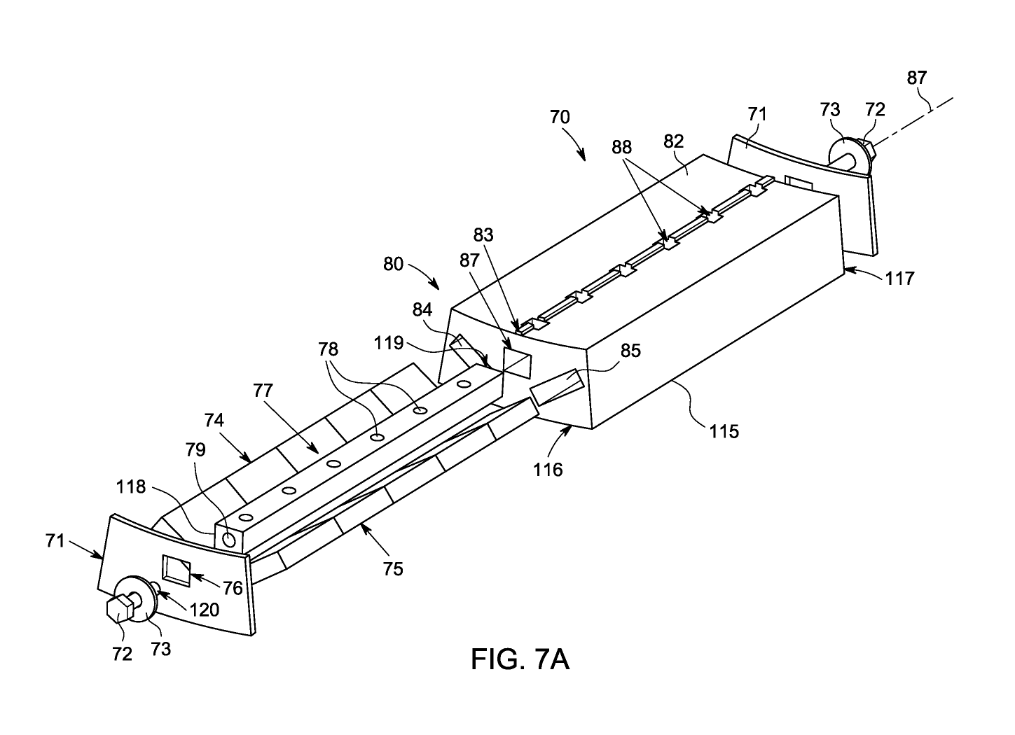

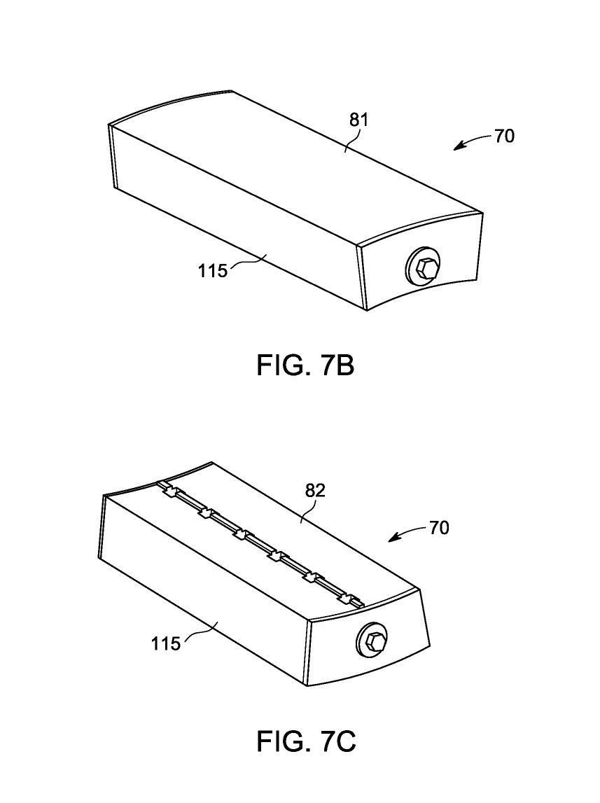

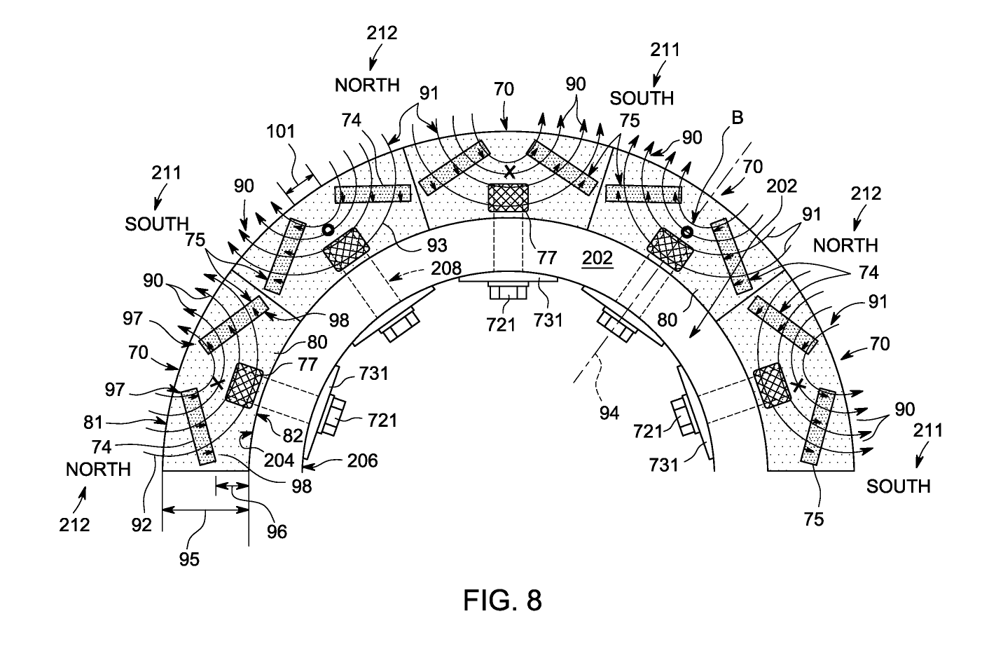

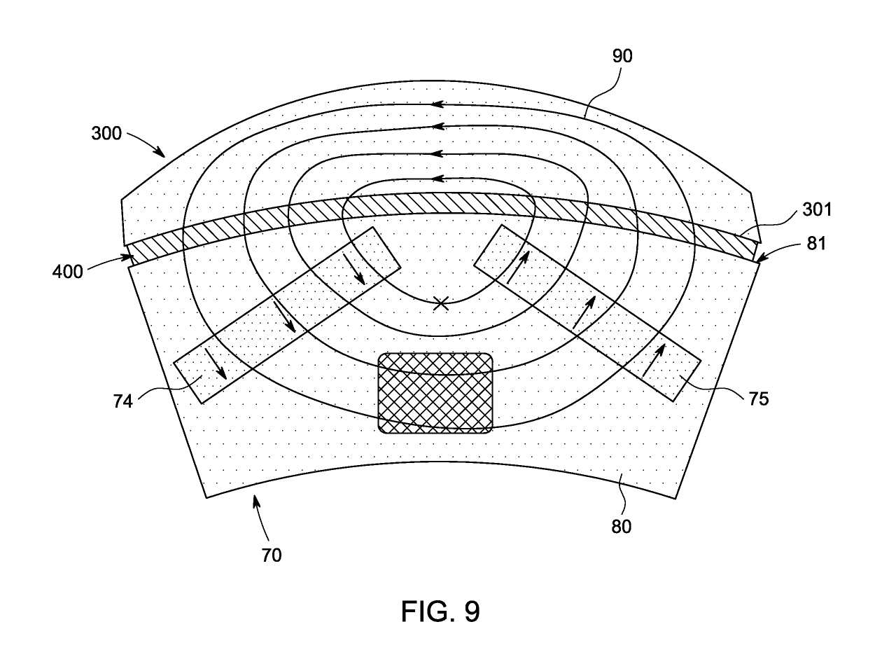

FIG. 7A is a perspective, exploded-parts view of an embodiment of a new split-pole magnetic module 70 for use as part of a split-pole permanent magnet rotor. FIG. 7B is a perspective top view of the embodiment of the split-pole magnetic module of FIG. 7A, shown assembled. FIG. 7C is a perspective bottom view of the embodiment of the split-pole magnetic module of FIG. 7B, shown assembled. FIG. 8 depicts one-half of an embodiment of a split-pole permanent magnet rotor 200 (hereinafter, “rotor 200”) of a large permanent magnet machine. The rotor 200 has multiple split-pole magnetic modules 70, such as the embodiment shown in FIGS. 7A, 7B and 7C, which are coupled with a rotor support structure 202.

Referring to FIGS. 7A, 7B, 7C and 8, the embodiment of the new split-pole magnetic module 70 comprises one or more of the following components: an end plate 71, a fastener 72, a washer 73, a first permanent magnet 74, a second permanent magnet 75, a compression bar 77, and a lamination stack 80. As shown in FIG. 7A, the permanent magnets 74 and 75 can be comprised of multiple smaller permanent magnet blocks.

Opposing flat sidewalls 115 of the lamination stack 80 connect its outer surface 81 with its parallel inner surface 82. In one embodiment, the outer surface 81 is convex and the inner surface 82 is concave. Since the outer surface 81 has a greater radius than the inner surface 82 in this embodiment, the sidewalls 115 slope inward from the longitudinal edges of the outer surface 81 to the longitudinal edges of the inner surface 82. As further shown and explained below with respect to FIG. 8, the angled, flat sidewalls 115 of the lamination stack 80 allow multiple split-pole magnetic modules 70 to be placed side-by-side around the circumference of a rotor support structure 202 to form a circle.

The compression bar 77 has a bore 79, dimensioned and shaped to receive a fastener 72, formed therethrough, from a first end 118 of the compression bar 77 to an opposite second end 119 of the compression bar 77. One or more holes 78 are formed through a surface of the compression bar 77 and may intersect the bore 79 (at least their axes may intersect, as the bore 79 would typically not be continuous). A portion of the interior surface of the holes 78 and a portion of the interior surface of the bore 79 are threaded to receive a threaded portion, or end, 120 of a fastener 72.

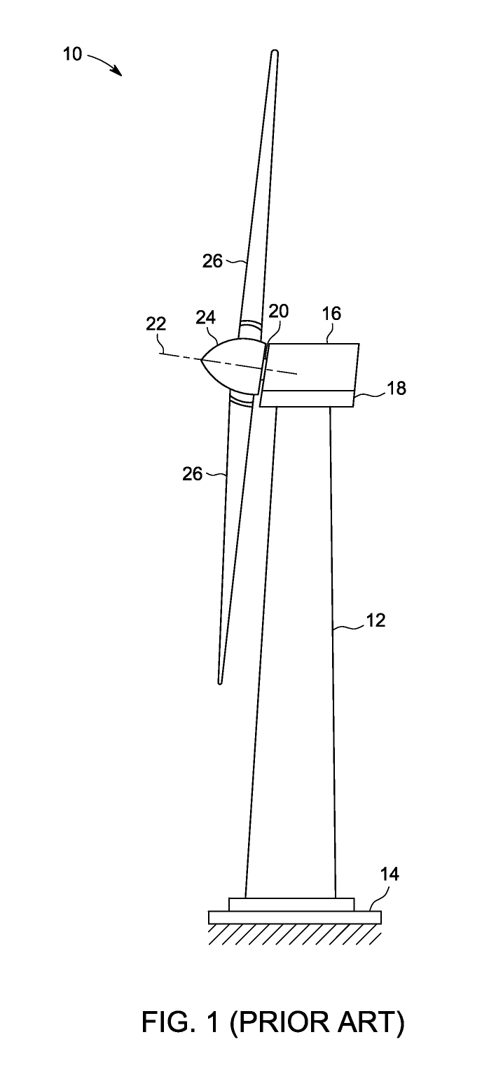

The lamination stack 80 has a central longitudinal axis 89. One or more of the lamination sheets are punched, cut or drilled to provide a bore 87, one or more fastener channels 88, and two or more magnet receptacles 84, 85 (hereinafter, “receptacles 84, 85”). When the lamination sheets are assembled to form the lamination stack 80, the bore 87, dimensioned and shaped to receive the compression bar 77 therein, is formed through the lamination stack 80 from one end 116 to an opposite end 117 along and parallel the longitudinal axis 89. One more fastener channels 88 are formed through the inner surface 82, along and perpendicular the lamination stack's longitudinal axis 89, to intersect the bore 87. In these regards, the lamination stack 80 is similar to the lamination stack 38 of FIG. 1.

An important difference, however, is that the new lamination stack 80 is configured to orient two or more permanent magnets 74, 75 such that the new split-pole magnetic module 70 has both a magnetic north pole and a magnetic south pole at the outer surface 81, rather than a single magnetic pole. Furthermore, as further explained below, and as illustrated in the Figures that follow, each magnetic north pole and magnetic south pole formed at the outer surface 81 of the lamination stack 80 is only a portion of a complete magnetic pole. This arrangement has several benefits. First, a magnetic circuit is completed within the mounting side of the split-pole magnetic module 70, which means that the rotor support structure 202 need not carry magnetic flux from one magnetic pole to another, unlike conventional rotor yokes. Secondly, as further described below and shown in the Figures that follow, the magnetic circuit on at the outer surface 81 can be easily closed via a single magnetic keeper comprised of any suitable ferromagnetic material, such as low-carbon steel.

Two or more receptacles 84 and 85, each dimensioned and shaped to receive the permanent magnets 74 and 75, respectively, are formed through the lamination stack 80, on either side of and parallel to the central longitudinal axis 89, from one end 116 of the lamination stack 80 to its opposite end 117. The one or more fastener channels 88 correspond to, and align with, the one or more holes 78 formed through the surface of the compression bar 78. Although only two permanent magnets 74, 75 and corresponding receptacle 84, 85 are illustratively shown, other embodiments may have multiple permanent magnets 74, 75 and corresponding receptacles 84, 85 that are positioned in either or both circumferential and axial directions. For large permanent magnet machines, such as generators and motors, use of two or more permanent magnets 74, 75 per split-pole magnetic module 70 is generally desirable to reduce electrical (e.g., eddy current) losses in the permanent magnets 74, 75 and/or to allow use of permanent magnets of a size that may be more readily manufactured and/or handled.

The permanent magnets 74, 75 can be formed of any hard magnetic material, including sintered NdFeB, bonded NdFeB, SmCo, Ferrite, and Alnico. In one embodiment, each permanent magnet 74, 75 is comprised of multiple sintered NdFeB permanent magnet blocks with a maximum energy product (BH) max of at least 35-40 MGOe and an intrinsic coercivity (H_{cJ}) of at least 1500 kA/m. N42SH is a common NdFeB material grade meeting the preferred embodiment properties.

The endplates 71 are preferably formed of a non-magnetic material such as aluminum or stainless steel. The fasteners 72 and washers 73 can be also formed of a non-magnetic material such as stainless steel, although in the preferred embodiment, they are formed of carbon steel to reduce cost. The compression bar 77 is preferably of a ferromagnetic material such as carbon steel, although it may also be formed of stainless steel, aluminum, or even a fiber-reinforced composite material such as G10 or G11. The lamination stack 80 is preferably formed of sheets of non-oriented electrical steel such as 0.5 mm thick M-19 or of any other thickness or grade ranging from 0.25 mm to 2 mm and M-15 to M-47.

Once the compression bar 77 is inserted into the bore 87 of the lamination stack 80, with its holes 78 aligned with the channels 88 of the lamination stack 80, and the first permanent magnet 74 is inserted within the receptacle 84 of the lamination stack 80, and the second permanent magnet 75 is inserted within the receptacle 85 of the lamination stack 80, end plates 71 are positioned adjacent the ends 116 and 117 of the lamination stack 80. Each end plate 71 has an aperture 76 therethrough, which is positioned and shaped to align with the bore 79 of the compression bar. The fastener 72, passing through a washer 73, is then inserted through the end plate aperture 76 and coupled with the bore 79 of the compression plate, and then tightened. At this point, the split-pole magnetic module 70 is assembled and ready for installation on a rotor support structure 202 of a permanent magnet machine.

Optionally, the compression bars 77 can be replaced with other means for stack compression and/or rigid mounting to the rotor support structure 202 (in FIG. 8). Non-limiting examples of these other means are: use of threaded rods or bolts extending axially through holes in the lamination stack 80, with nuts on at least one end. For rigid mounting to a rotor support structure 202, these other means also include a dovetail arrangement, comprising a dovetail extension (radially) of the lamination stack 80, and/or end plates, that interlock with mating features in the rotor support structure 202 to prevent radial and circumferential movement of the split-pole magnetic modules. In one embodiment, additional end features, such as mechanical stops, are introduced to prevent axial movement of the split-pole magnetic modules 70.

Referring to FIGS. 7A and 8, each receptacle 84 and 85 is angled at a predetermined angle with respect to the other. For example, as shown in FIG. 8, first ends 97 of each receptacle 84, 85, proximate the outer surface 81 of the lamination stack 80, are positioned close together, while the opposite second ends 98 of each receptacle 84, 85 are positioned further apart. Stated differently, the first ends 97 and second ends 98 of the receptacles 84, 85 are positioned at different distances from the inner surface 82 of the split-pole magnetic module 70. For example, the first ends 97 of the receptacles 84, 85 are positioned a first distance 95 from the inner surface 82, and the second ends 98 of the receptacles 84, 85 are positioned a second distance 96 from the inner surface 82. Thus, the first ends 97 of the receptacles 84, 85 are proximate the outer surface 81 and the second ends 98 of the receptacles 84, 85 are proximate the inner surface 82. This arrangement enables the first magnetic flux 90 and the second magnetic flux 91 to flow between and through the permanent magnets 74 and 75 in each separate split-pole magnetic module 70.

An advantage of this inclined orientation of the receptacles 84, 85, and the permanent magnets 74,75 placed therein, is that the magnetic flux 90 and 91 from the permanent magnets 74, 75 does not pass through (e.g., is not carried by) the rotor support structure 202. Accordingly, the rotor support structure 202 associated with embodiments of the invention can be made lighter and thinner than prior versions. Additionally, the rotor support structure 202 can comprise a non-ferromagnetic material, such as aluminum, stainless steel or even a composite material. Another advantage of the split-pole magnetic module configuration is that each split-pole magnetic module 70 has a single magnetic flux 90 or 91, which is substantially uniform.

Another advantage of this arrangement is that the inclined orientation of the at least two permanent magnets 74, 75 concentrates the magnetic flux 90, 91, thereby increasing the magnetic loading of a large permanent magnet machine, and as a result may reduce the machine's overall size for a given rating. Alternatively, the inclined orientation may potentially reduce the amount or grade of permanent magnets 74, 75 required for a large permanent magnet machine by enabling each permanent magnet 74, 75 to operate at a more optimal internal flux level.

FIG. 8 illustrates a section of an embodiment of a rotor 200 for use in a large permanent magnet machine. The rotor 200 utilizes multiple split-pole magnetic modules 70, which are removably coupled with a rotor support structure 202 using fasteners 72 and washers 73. It is seen that in one embodiment, to achieve the alternating pattern of magnetic north poles 91 and magnetic south poles 90, the north/south orientation of the permanent magnets 74, 75 in each split-pole magnetic module 70 are alternated between successive (e.g., adjacent) split-pole magnetic modules 70. In another embodiment, a single type of split-pole magnetic module 70 is provided, wherein the orientation of the magnetic poles 90, 91 is identical for each split-pole magnetic module 70. In such a case, split-pole magnetic modules 70 are merely successively flipped 180 degrees to achieve the alternating pattern of magnetic north poles 91 and magnetic south poles 90. In such an embodiment, for ease of assembly and to avoid mistakes, one side (or end) of each split-pole magnetic module 70 is labeled with a predetermined marker, which denotes the magnetic north or south orientation.

As shown in FIG. 8, each split-pole magnetic module 70 is removably coupled with the rotor support structure 202 by the one or more fasteners 721 that protrude through corresponding washers 731, which engage the inner surface 206 of the rotor support structure 202. The fasteners 721 pass through channels 208 formed through the rotor support surface 202 and channels 88 formed through the inner surface 82. In one embodiment, a portion of the fasteners 721 is threaded to engage corresponding threads formed on an interior surface of the holes 78 formed in the compression bar 77.

The fasteners 721 can be any suitable fastening mechanism. In one embodiment, each fastener 721 is a bolt having a head on one end and a threaded portion on the other end. Each fastener 721 comprises a metal, a metal alloy or combination thereof, e.g., carbon steel.

Each washer 731 comprises a metal, a metal alloy or combination thereof (e.g., carbon steel), and may be curved or shaped to mate flush with the curved inner surface 206 of the rotor support structure 202.

As shown in FIG. 8, each split-pole magnetic module 70 has split magnetic poles, a magnetic north pole 91 on one side of the split-pole magnetic module 70 and a magnetic south pole 90 on the opposite side of the split-pole magnetic module 70. Consequently, a first magnetic flux 92 flows through a first lamination stack 80, entering at a first portion of the outer surface 81 and exiting at a second portion of the outer surface 81. When illustrated in cross-section as shown in FIG. 8, the first magnetic flux 92 appears to flow in first direction, e.g., counterclockwise. Additionally, a second magnetic flux 93 flows through a second lamination stack 80, entering at a first portion of the outer surface 81 and exiting at a second portion of the outer surface 81. When illustrated in cross-section as shown in FIG. 8, the second magnetic flux 93 appears to flow in a second direction, opposite the first direction, e.g., clockwise.

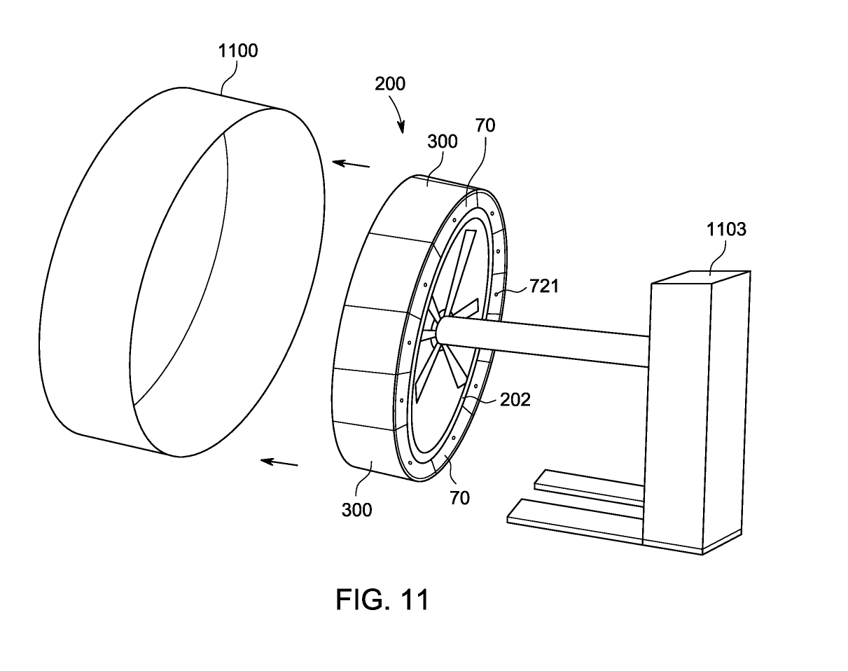

When multiple split-pole magnetic modules 70 are positioned as shown in FIG. 8 (and FIG. 10), an advantage results in that the partial magnetic poles 90, 91 of adjacent permanent magnets 74, 75, located in adjacent but different split-pole magnetic modules 70, combine to form common magnetic poles 211 and 212. For example, as shown in FIG. 8, the partial magnetic south poles 90 of adjacent permanent magnets 75, located in adjacent but separate split-pole magnetic modules 70, combine to form a common south pole 211. Similarly, the partial magnetic north poles 91 of adjacent permanent magnets 74, located in adjacent but separate split-pole magnetic modules 70, combine to form a common north pole 212. Thus, the multiple split-pole modules combine to create a conventional and desirable alternating magnetic field distribution at the outer surface of the rotor.

Although embodiments of the invention are mostly described herein with reference to an outer stator/inner rotor configuration for large permanent magnet machines, embodiments of the invention are also equally applicable to inner-stator/outer rotor configurations in which the split-pole magnetic modules 70 are attached to an inside of the rotor support structure 202 and in which the split-pole magnetic module outer surfaces 81 and the stator are internal to the rotor 200.

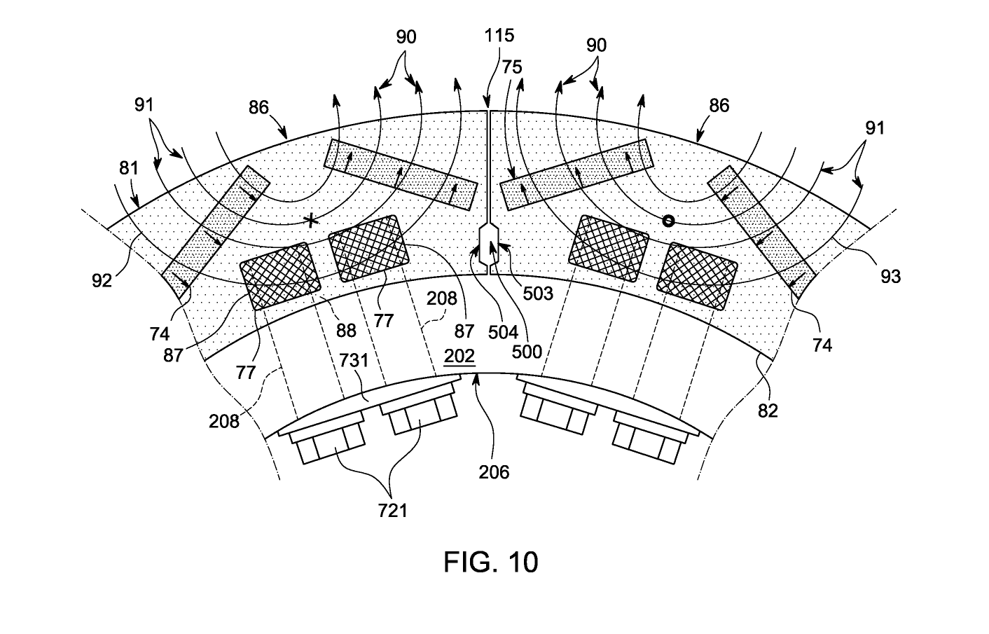

FIG. 9 depicts an embodiment of a magnetic keeper 300 and a non-magnetic spacer 400 that are coupled with the split-pole magnetic module 70 of FIGS. 7A, 7B, 7C and 8 to trap and retain the magnetic flux 90 flowing between the permanent magnets 74 and 75. Closing the magnetic circuit of each split-pole magnetic module 70 at the outer surface 81 with the magnetic keeper 300 ensures the magnetic circuit of each split-pole magnetic module 70 is completely enclosed and contained. This greatly simplifies the process of split-pole magnetic module assembly, handling, rotor mounting, and insertion of the rotor 200, with split-pole magnetic modules 70 attached and comprising pre-magnetized permanent magnets 74, 75, into a stator (not shown for ease of illustration). The ability to completely close the magnetic circuit of each individual split-pole magnetic module with a simple keeper 300 (and optional spacer 400) during the complete assembly process is a key advantage of this invention, unlike the magnetic circuits of the individual pole modules of the prior art (FIGS. 5 and 6) which cannot be readily closed with a simple single keeper during the assembly process.

The magnetic keeper 300 comprises any ferromagnetic material, such as carbon steel. The magnetic keeper 300 has an inner surface 301, which is contoured to mate with the outer surface 81 of the lamination stack 80 of the split-pole magnetic module 70. The magnetic keeper 300 is sized to cover all, or substantially all, of the length of the permanent magnets 74, 75, and sized to carry the magnetic flux 92, 93 without excess saturation, or at least without excessive magnetic flux 92, 93 leaking beyond the magnetic keeper/split-pole magnetic module assembly. In one embodiment, a radial depth of the magnetic keeper is at least one-half a width of the permanent magnet 74 or 75. Optionally, the magnetic keeper 300 comprises a non-ferromagnetic material of sufficient thickness to keep magnetic flux beyond the magnetic keeper 300, and/or the split-pole magnetic module 70, to a predetermined safe level.

The non-magnetic spacer 400 comprises any non-ferromagnetic material, such as polytetrafluoroethylene, an aramid (and/or meta-aramid) material, an epoxy/glass laminate material, (such as National Electrical Manufacturers Association (NEMA) G10 or G11, etc.) The non-magnetic spacer 400 is sandwiched between the magnetic keeper 300 and the outer surface 81 and serves several purposes. First, it prevents direct contact between the keeper 300 and the outer surface 81 of the split-pole magnetic module 70 from damaging the split-pole magnetic module 70. Additionally, it reduces an amount of magnetic force existing between the magnetic keeper 300 and the split-pole magnetic module 70, which makes it easier to separate the magnetic keeper 300 from the split-pole magnetic module 70 during manufacture of a rotor, such as the rotor 200 of FIG. 7. In one embodiment, the magnetic keeper 300 is axially slid from the split-pole magnetic module 70 during final assembly of the rotor 200 into a stator (not shown). Additionally, the non-magnetic spacer 400 provides a low-friction interface to reduce sliding forces, and provides scratch protection and/or corrosion protection of the outer surface 81. The thickness of the non-magnetic spacer 400 varies depending on factors such as dimensions of the split-pole magnetic module 70, strength of the permanent magnets 74, 75, its material properties, and the like. However, in one embodiment, the non-magnetic spacer 400 is at least 0.25 mm thick, but may be up to, and including, about 5.0 mm thick.

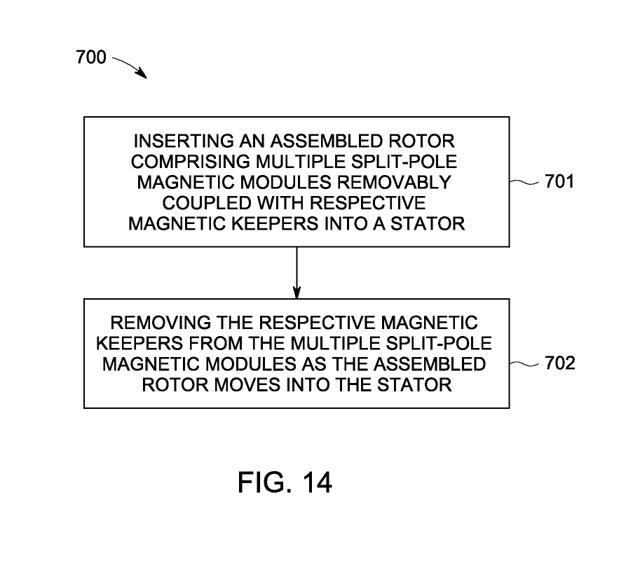

Due to the relatively large magnetic fields used in each split-pole magnetic module 70, attempts to install split-pole magnetic modules 70 without a magnetic keeper 300 installed would be challenging, as the split-pole magnetic module 70 would be strongly attracted to any nearby magnetic object, such as an adjacent, and previously installed, split-pole magnetic module 70. Use of the magnetic keeper 300 therefore, greatly reduces some of the complexities and challenges formerly associated with manufacturing rotors for permanent magnet machines. Based on experimental data, it is recommended that the magnetic keeper(s) 300 be removed at about the same time the split-pole magnetic module 70 (and/or an assembled rotor 200) is inserted within a stator of a large permanent magnet machine. An embodiment of a method for doing this is shown in FIG. 13 and further explained below.

FIG. 10 depicts an alternative embodiment of a rotor 200 having one or more alternative split-pole magnetic modules 86 coupled by two fasteners 72 to a rotor support structure 202. Each split-pole magnetic module 86 is configured as the split-pole magnetic module 70 previously described, but with several variations. For example, each split-pole magnetic module 86 has an outer surface 81 and a parallel inner surface 82. Opposing sidewalls 115 connect the longitudinal edges of the outer surface 81 with the longitudinal edges of the inner surface 82. Each split-pole magnetic module 86 also comprises two receptacles 84, 85, configured and positioned as previously described. Receptacle 84 contains the first permanent magnet 74, and receptacle 85 contains the second permanent magnet 75. However, unlike the split-pole magnetic module 70, each split-pole magnetic module 86 comprises two bores 87. These bores 87 are positioned on either side of and parallel to the central longitudinal axis 89 (FIG. 7A), and each contains a compression bar 77. Each of the two compression bars 77 is configured as previously shown and described. Moreover, unlike the split-pole magnetic module 70, each split-pole magnetic module 86 further comprises two holes 88 formed through its inner surface 82. Each hole 88 intersects its own respective bore 87. Additionally, the rotor support structure 202 comprises two holes 208, which are of the same or similar diameter as the holes 88 formed in the split-pole magnetic module 86. Another difference is that a single washer 73 is paired with two fasteners 72, one for each hole 208 and 88, and engages the inner surface 206 of the rotor support structure 202, as shown. Thus, in contrast to the split-pole magnetic module 70, each split-pole magnetic module 86 is fastened with spaced-apart pairs of fasteners 72 along its length. This alternative embodiment may be preferable for high-speed applications wherein large centrifugal forces act on the modules and fasteners.

Another difference between the split-pole magnetic module 70 and the split-pole magnetic module 86 is that each split-pole magnetic module 86 is provided with an axial groove 501, 503 in at least one of its sidewalls 115. Each axial groove 501, 503 is a portion of a cooling duct 500. Many positions and configurations are possible and contemplated, but in one exemplary embodiment, each axial groove 501, 503 is integrally formed in a portion of the sidewall 115 that is proximate the inner surface 82 of the split-pole magnetic module 86. Accordingly, when two split-pole magnetic modules 86 are positioned adjacently, as shown in FIG. 10, each axial groove 501, 503 mates with the other to form the cooing duct 500 between each split-pole magnetic module 86. This is advantageous in that a cooling fluid, such as, but not limited to air, water, etc., can be passed through the assembled cooling duct 50 to entrain and draw heat away from each split-pole magnetic module 86. That said, in an embodiment, where cooling fluids other than air, such as liquids, are used, each assembled cooling duct 50 may contain a cooling tube (not shown) inserted therein. Thus, use of the assembled cooling duct 500, with or without a cooling tube positioned therein, can improve performance and extend each split-pole magnetic module's operating life.

Although not expressly shown in the Figures, it is understood that one or more sidewalls 115 of the split-pole magnetic module 70, of FIGS. 7A, 7B, 7C and 8 can be modified to include a portion of the duct 500, as shown in FIG. 10.

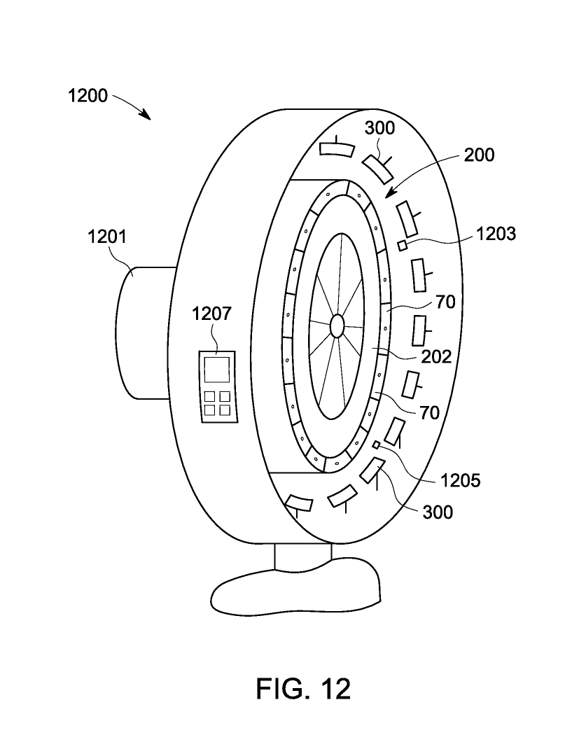

FIG. 11 illustrates insertion of an embodiment of a completed rotor 200, with split-pole magnetic modules 70 and magnetic keepers 300 attached, into a stator 1100 during assembly of a large permanent magnet machine. A fixture 1103 inserts the rotor 200 into the stator 1100, and simultaneously, the magnetic keepers 300 are axially slid off the split-pole magnetic modules 70 as the rotor 200 enters the stator 1100. By assembling in this manner, the magnetic fields and forces are fully contained within the magnetic keepers 300, the fixture 1103 and/or stator 1100 structures during the assembly, thereby improving safety for personnel.

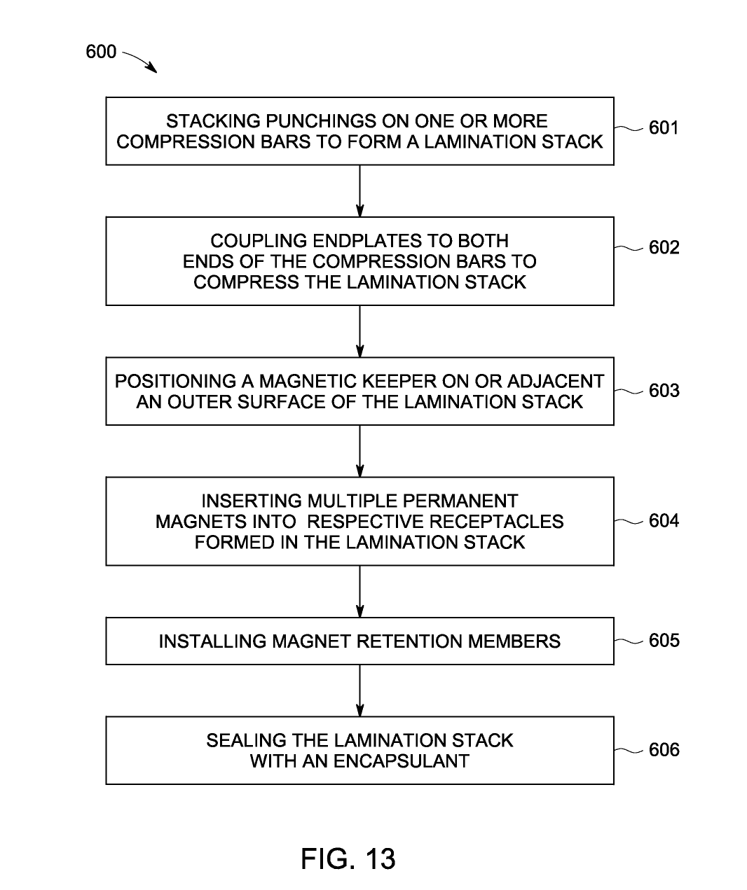

FIG. 12 illustrates an optional mechanism for testing and/or correcting balance of a rotor 200, which comprises multiple split-pole magnetic modules 70, after the rotor 200 is fully assembled, but before it is inserted within a stator. A fixture 1200 surrounds the rotor 200 and temporarily retracts and holds the magnetic keepers 300 away from the split-pole magnetic modules 70. A drive motor 1201 spins the rotor 200, and appropriate sensors 1203, 1205 coupled with one or more computers 1207 determine whether balancing is required. Balance correction is achieved by any known method, such as drilling holes in the rotor support structure 202, attaching weights to the rotor support structure 202, etc. After the rotor 200 is balanced, the fixture 1200 returns the magnetic keepers 300 to the split-pole magnetic module, and the rotor 200 is removed from the fixture 1200 for insertion into a stator 1100 (FIG. 11).

Methods of Manufacture and/or Assembly

FIG. 13 depicts an embodiment of a method 600 of assembling a split-pole magnetic module 70 using the magnetic keeper 300 of FIG. 9. Referring to FIGS. 7A, 7B, 7C, 8, 9, 10, 11 and 13, the method 600 begins by stacking 601 punchings on one or more compression bars 77 to form a lamination stack 80. Alternatively, the punchings are stacked and aligned on a jig to form the lamination stack 80, with the one or more compression bars inserted thereafter. The method 600 further comprises coupling 602 the endplates 71 to both ends of the compression bars 77 to compress the lamination stack 80. The method 600 further comprises positioning 603 a magnetic keeper 300 and non-magnetic spacer 400 on or adjacent an outer surface 81 of the lamination stack 80.

The method 600 further comprises inserting 604 multiple permanent magnets 74, 75 into respective receptacles 84, 85. This can be accomplished in either of two ways: (a) compressing the lamination stack 80 and then inserting magnets through openings in one of two end plates 71, or (b) alternatively, adding “top” end plates 71 (without openings) and doing final compression after magnets 74, 75 are inserted.

The method 600 further comprises installing 605 magnet retention members. Optionally, the method 600 further comprises sealing 606 the compression stack 80 with an encapsulant. In one embodiment, the encapsulant is a resin that is applied to the lamination stack 80 by one of potting, Vacuum Pressure Impregnation (VPI), dipping or other suitable technique. The permanent magnets 74, 75 may inserted either in an unmagnetized state or in a fully magnetized state. The permanent magnets are preferably inserted in a fully magnetized state for low-volume production to avoid the high costs associated with developing a magnetizer powerful enough to magnetize after insertion. Conversely, for high-volume applications, the permanent magnets 74, 75 are inserted in an unmagnetized state, and then magnetized in a magnetizer after complete assembly of the module 70.

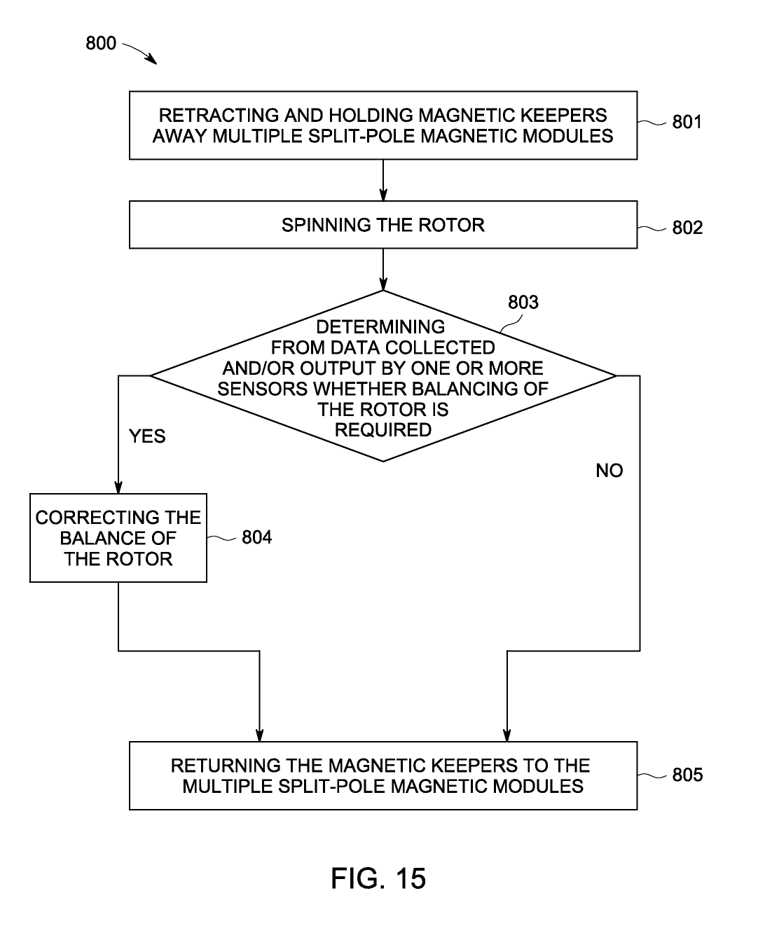

FIG. 14 depicts an embodiment of a method 700 for inserting the rotor 202 of either FIG. 8 or FIG. 10 into a stator (1100 of FIG. 11) while removing magnetic keepers 300 from the split-pole magnetic modules 70. Referring to FIGS. 7A, 7B, 7C, 8, 9, 10, 11 and 14, the method 700 begins inserting 701 an assembled rotor 202 comprising multiple split-pole magnetic modules 70 removably coupled with respective magnetic keepers 300 into a stator 1100. The method 700 further comprises removing 702 the respective magnetic keepers 300 from the multiple split-pole magnetic modules 70 as the assembled rotor 202 moves into the stator 1100.

FIG. 15 depicts an embodiment of a method 800 for balance testing a rotor 202 comprising multiple split-pole magnetic modules 70 that are removably coupled with respective magnetic keepers 300. Referring to FIGS. 7A, 7B, 7C, 8, 9, 10, 12 and 15, the method 800 begins by retracting and holding 801 the magnetic keepers 300 away from the multiple split-pole magnetic modules 70. The method 800 further comprises spinning 802 the rotor 202. The method 800 further comprises determining 803 from data collected and output by one or more sensors whether balancing is required. If balancing is required, the method 800 further comprises correcting 804 the balance of the rotor 202 and returning 805 the magnetic keepers 300 to the multiple split-pole magnetic modules 70. Otherwise, the method 800 further comprises returning 805 the magnetic keepers 300 to the multiple split-pole magnetic modules 70.

### DEFINITIONS

Unless indicated otherwise herein, the following terms mean:
Split-pole Magnetic Module: an embodiment of the split-pole magnetic module shown and described herein, having a compression stack in which multiple permanent magnets are oriented to produce a first magnetic pole on one portion of an outer surface of the lamination stack and to produce a second, opposite magnetic pole on a second portion of the outer surface.

Embodiments of the invention apply to large permanent magnet machines with relatively high split-pole magnetic module counts, such as between, and including, 10 to 90, and are also applicable to such machines having fewer or greater number of split-pole magnetic modules. Particular embodiments of the invention may be adapted for electrical machines having large diameters, such as, but not limited to, multi-MW direct drive generators for wind turbines, as well as medium speed (e.g., about 200-500 RPM) multi-MW generators.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A split-pole magnetic module, comprising:
an outer surface; and
multiple permanent magnets inclined at an orientation that causes magnetic to enter a first portion of the outer surface and to exit a second portion of the outer surface.

2. The split-pole magnetic module of claim 1, further comprising:
a magnetic keeper removably coupled with the outer surface.

3. The split-pole magnetic module of claim 2, further comprising:
a non-magnetic spacer sandwiched between the magnetic keeper and the outer surface.

4. A large permanent magnet machine having the split-pole magnetic module of claim 1.

5. A rotor, comprising:
a rotor support structure; and
the split-pole magnetic module coupled with the rotor support structure, the split-pole magnetic module comprising:
an outer surface; and
multiple permanent magnets inclined at an orientation that causes magnetic to enter a first portion of the outer surface and to exit a second portion of the outer surface.

6. The rotor of claim 5, wherein the rotor support structure comprises a non-ferromagnetic material.

7. A method, comprising:
stacking punchings having openings formed therein on a compression bar to form a lamination stack having magnet receptacles formed by the openings in each punching;
coupling an end plate to each end of the compression bar to compress the lamination stack;
positioning a magnetic keeper on or adjacent an outer surface of the lamination stack;
inserting multiple permanent magnets into the magnet receptacles formed in the lamination stack; and
installing magnet retention members.

8. The method of claim 7, further comprising:
sealing the lamination stack with an encapsulant.

9. A method, comprising:
inserting an assembled rotor comprising multiple split-pole magnetic modules removably coupled with respective magnetic keepers into a stator; and
removing the respective magnetic keepers from the multiple split-pole magnetic modules as the assembled rotor moves into the stator.

10. A method, comprising:
retracting and holding magnetic keepers away from multiple split-pole magnetic modules that comprise part of an assembled rotor;
spinning the rotor; and
determining using a computer from data collected and/or output by one or more sensors whether balancing of the rotor is required.

11. The method of claim 10, further comprising:
correcting the balance of the rotor.

12. The method of claim 11, further comprising:
returning the magnetic keepers to the multiple split-pole magnetic modules.

13. A split-pole magnetic module, comprising:
a lamination stack having magnet receptacles formed therein and angled relative to each other; and
a permanent magnet positioned in each of the magnet receptacles, wherein a first permanent magnet has a magnetic polarity opposite a magnetic polarity of a second permanent magnet such that magnetic flux enters a first portion of the outer surface and exits a second portion of the outer surface.

14. The split-pole magnetic module of claim 13, further comprising:
an annular groove formed on a portion of a sidewall of the lamination stack, wherein the annular groove is a portion of a cooling duct.

15. A split-pole magnetic module, comprising:
an end plate having an aperture formed therein;
a fastener;
a washer having an opening therein that is sized to permit the fastener to extend therethrough;
a first permanent magnet having a first magnetic pole that has a first polarity;
a second permanent magnet having a second magnetic pole that has a second polarity, which is opposite the first polarity;
a compression bar having a bore formed therein parallel to a longitudinal axis of the compression bar and having one or more spaced apart holes formed therein, aligned along and perpendicular to the longitudinal axis of the compression bar; and
a lamination stack having a bore formed therein parallel to a longitudinal axis of the lamination stack, a plurality of spaced apart fastener channels formed therein and aligned along and perpendicular to the longitudinal axis of the lamination stack, a first magnet receptacle formed therein parallel to, and angled with respect to, the longitudinal axis of the lamination stack and positioned on one side thereof, and a second magnet receptacle formed therein parallel to, and angled with respect to the longitudinal axis of the lamination stack and positioned on an opposite side thereof, the lamination stack having an outer surface and an inner surface.

16. A magnetic keeper, comprising:
a ferromagnetic material dimensioned and shaped to cover a portion of an outer surface of a lamination stack of a split-pole magnetic module and to complete a magnetic circuit at the outer surface so that magnetic flux does not extend beyond the magnetic keeper and/or the split-pole magnetic module.

17. The magnetic keeper of claim 16, wherein the split-pole magnetic module comprises:
an outer surface, and
multiple permanent magnets inclined at an orientation that causes magnetic flux to enter a first portion of the outer surface and to exit a second portion of the outer surface.
